(19) United States
(12) Patent Application Publication
(10) Pub. No.: US 2014/0100896 A1
(43) Pub. Date: Apr. 10, 2014

(54) TICKET VALIDATION AND ELECTRONIC CONVERSION OF TICKETS

(71) Applicant: Live Nation Entertainment, Inc., Beverly Hills, CA (US)

(72) Inventors: Fengpei Du, Santa Monica, CA (US); Samuel P. Levin, Los Angeles, CA (US); Richard DiStefano, Burbank, CA (US)

(73) Assignee: Live Nation Entertainment, Inc., Beverly Hills, CA (US)

(21) Appl. No.: 14/049,909

(22) Filed: Oct. 9, 2013

Related U.S. Application Data
(60) Provisional application No. 61/712,009, filed on Oct. 10, 2012.

(51) Int. Cl. G06Q 10/02

(52) U.S. Cl. CPC G06Q 10/02
USPC 705/5

(57) ABSTRACT

Systems and methods for validating physical tickets and for converting physical tickets to electronic tickets are described. Optionally, a physical ticket may be authenticated using information accesses from a ticket issuer database. Optionally, a user may transfer a validated ticket and/or an electronic ticket to another user.

This application claims the benefit of and claims priority to U.S. Provisional Application No. 61/712,009, filed Oct. 10, 2012, which is hereby incorporated by reference in its entirety for all purposes.

### BACKGROUND OF THE INVENTION

1. Field of the Invention

The present invention is related to electronic tickets.

2. Description of the Related Art

Conventionally, fans purchasing tickets in the secondary market are typically not able to validate the authenticity of the purchased ticket purchased until they try to access the event, at which point the event venue will attempt to validate the ticket. If the ticket's authenticity is validated, the ticket bearer will be admitted. However, if the ticket's authenticity is not validated and turns out to be a counterfeit ticket, the ticket bearer will be denied entry, and the money paid for the ticket is lost. Not only do invalid, counterfeit tickets cause fans to lose money and time, they result in the presence of angry, cheated fans at the event venue.

### SUMMARY OF THE INVENTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain embodiments enable a user to validate a physical, printed ticket using a camera built into their phones, mp3 players, tablet computer, or other device. Certain embodiments enable ticket holders to convert their physical, hard ticket to a digital electronic, ticket.

Certain optional embodiments provide a method of processing a physical ticket for a ticketed event, the method comprising: providing an application for installation on a user device, the application configured to perform operations, comprising: enabling monitoring of a camera feed from the user device by a computer system, the camera feed including one or more images. The computer system may detect, at least in part from the camera feed, if a first ticket feature of the physical ticket is included in the camera feed, the first ticket feature optionally including at least a first machine readable code. After the first ticket feature is detected in the camera feed, the computer system and/or other system performs operations including some or all of the following: determining at least in part from the first machine readable code and from data accessed from a database of an issuer of the physical ticket if the physical ticket is valid; at least partly in response to determining that the physical ticket is not valid, providing a corresponding invalid indication to the user via the user device; at least partly in response to determining that the physical ticket is valid: providing a corresponding valid indication to the user via the user device; enabling a user to cause an electronic ticket corresponding to the physical ticket to be provided to the user device; at least partly in response to an indication that the physical ticket is converted into an electronic ticket, providing for display on the user device a second machine readable code identifying the electronic ticket, wherein the second machine readable code is configured to be scanned by a venue scanner in order to a gain admission to the ticketed event.

An example embodiment provides a system for processing a physical ticket for a ticketed event, the system comprising: a camera feed monitoring system configured to monitor a camera feed of a user device, the camera feed including one or more images; a feature detection system configured to detect, at least in part from the camera feed, if a first ticket feature of a physical ticket is included in the camera feed, the first ticket feature including at least a first machine readable code; a ticket validation system configured to: determine, at least in part from the first machine readable code and from data accessed from a database of an issuer of the physical ticket, if the physical ticket is valid; at least partly in response to determining that the physical ticket is not valid, provide a corresponding invalid indication to the user via the user device; at least partly in response to determining that the physical ticket is valid: provide a corresponding valid indication to the user via the user device; enable a user to cause an electronic ticket corresponding to the physical ticket to be provided to the user device; a ticket issuance system configured to, at least partly in response to an indication that the physical ticket is converted into an electronic ticket, provide for display on the user device a second machine readable code corresponding to the electronic ticket.

### BRIEF DESCRIPTION OF THE DRAWINGS

Embodiments will now be described with reference to the drawings summarized below. These drawings and the associated description are provided to illustrate example embodiments, and not to limit the scope of the invention.

FIGS. 1-3 illustrate example user interfaces.

FIG. 4 illustrates an example architecture.

FIG. 5 illustrates an example or a process performed at a mobile device to coordinate conversion of a physical ticket to an electronic ticket.

FIG. 6 illustrates an example or a process performed at a mobile device to coordinate conversion of a physical ticket to an electronic ticket.

FIG. 7 depicts a block diagram of an embodiment of a computer system.

FIG. 8 depicts a block diagram of an embodiment of a special-purpose computer system.

### DETAILED DESCRIPTION OF PREFERRED EMBODIMENTS

Systems and methods are described for validating tickets and for converting physical tickets to electronic tickets.

It is common for tickets to be sold in the secondary market, where tickets are resold by a ticket purchaser to another ticket purchaser. As similarly discussed above, conventionally, fans purchasing tickets in the secondary market are typically not able to validate the authenticity of the purchased ticket purchased until they try to access the event, at which point the event venue will attempt to validate the ticket. If the ticket is validated, the ticket bearer will be admitted. However, if the ticket is not validated and turns out to be a counterfeit ticket or a ticket that has already been utilized to gain admission, the ticket bearer will be denied entry, and the money paid for the ticket is lost. Not only do invalid and counterfeit tickets cause fans to lose money and time, they result in the presence of irate, cheated fans at the event venue.

Further, fans also experience many inconveniences owning hard, physical tickets, such as risking the loss or misplacement of tickets, having to remember to bring their tickets on the day of the event, having to overcome friction points in transferring tickets, and dealing with pricing and logistics friction points in selling tickets to another fan.

Certain embodiments described herein provide a mobile scanner feature that may solve some or all of the foregoing problems by offering fans an easy and reliable way to validate a physical, printed ticket using a camera built into their phones, mp3 players, tablet computer, or other device. Certain embodiments further provide ticket holders an easy way to convert their physical, hard ticket (e.g., event ticket) to a digital electronic ticket, enabling ticket holders to efficiently and securely transfer and sell their tickets electronically.

As will be described in greater detail below, the user device may be used to capture an image of a ticket or a portion thereof, which is then analyzed to determine whether the ticket is authentic, expired, or used up (e.g., already used to access the ticketed event).

In addition, data collected via such images and the analyses of such images may be used to notify venue operators, promoters, event performers, the initial ticket seller, and/or other entity where and when validation events and ticket resales are occurring, and upon detecting certain numbers or rates of counterfeit tickets (e.g., meeting certain thresholds, where the threshold for the number of tickets may be 1 or more than 1, and the threshold for the rate may be 1/day, 2/day or other rate), send early-warning signals of possible mass-scale ticket fraud to some or all of the foregoing entities.

A ticket verification and/or conversion application, sometimes referred to in abbreviated form as a ticketing app, may be downloaded to, preinstalled on, or accessed by a user device (e.g., a phone, tablet computer, laptop computer, interactive television, etc.) incorporating a camera, a display, such as a touch display, and a network interface, such as an interface to a cellular network, a Wi-Fi network, and/or other network. The ticketing app may be provided by or on behalf of an original ticket issuer.

In an example embodiment, when the user accesses the ticketing app on the user device (e.g., by tapping on an icon representing the ticketing app), the ticketing app launches. The ticketing app may provide or access a user interface, which is displayed on the user device. The ticketing device may also access the user device's camera and present objects, such as an event ticket, imaged by the camera, in the user interface. The user interface may include a target reticle, which may be in the form of a box, cross-hairs, or other form.

The user may activate a control, such as a scan control and/or a validation control. The app may automatically provide a flashlight function (e.g., by causing an LED light or other light source of the user device to turn on so as to illuminate the ticket) when scanning a ticket or ticket feature. The user may be instructed to position the camera or ticket so that the entire ticket, or a specified portion of the ticket, falls within or is centered on the reticle. For example, the user may be instructed to position the camera so that a barcode (e.g., one or more of barcode formats: QR code, Code 39, Extended Code 39, Code 128, UCC/EAN-128, Industrial 2 of 5 Planet, Interleaved 2 of 5, Codabar, UPC-A, UPC-E, EAN 13, EAN 8, BOOKLAND, MSI, Code 11, Code 93, PDF417, POSTNET, PLANET, other format, etc.), hologram, text, or other feature that includes authentication information and ticket identification information. For example, the feature (e.g., a barcode) may include an encrypted serial number uniquely identifying the ticket. The serial number may be encrypted using a first key, such as a private key, and decrypted using a second key, such as a public key.

While the user attempts to appropriately position the ticket or ticket feature with respect to the reticle, the app monitors the image. Once the app determines that the feature is properly positioned in the reticle, the app automatically (or in response to a user command) begins the validation process, and appropriate feedback is provided to the user (e.g., a green symbol indicating the ticket or ticket feature is appropriately positioned and/or a corresponding text message, instructing the user how to position the camera and/or ticket so ensure the ticket is properly aligned with respect to the camera, etc.). Thus, in certain embodiments, the application itself initiates the ticket validation in response to the recognition of the barcode and so, optionally, the user is not required to activate a validation control after having properly positioned the ticket or ticket feature with respect to the reticle or camera view. The validation may optionally be performed by the original ticket issuer and/or by the app using data provided by the initial ticket issuer.

The app may perform an image analysis and isolate the feature incorporating the encrypted serial number. Various techniques may be used to identify the feature. For example, texture segmentation and/or partial line scanning may be used. Other, more computation intensive techniques, such as morphological operations, may also be utilized. The image may be preprocessed in order to eliminate or reduce shadows and/or excessive light.

The app then extracts and decrypts the serial number (e.g., utilizing the appropriate key). The app determines from the serial number whether the ticket is authentic. For example, the app may determine whether the serial number is valid by determining whether it is compliance with certain serial number rules (e.g., as defined by the original ticket issuer), such as whether it contains certain a specified number of characters (e.g., ASCII characters), patterns of characters and/or sequences of characters. By way of further example, the app may instead or in addition compare the scanned ticket serial number to serial numbers in a database of valid, non-expired serial numbers (e.g., wherein the serial numbers are provided by the original ticket issuer and/or the comparison is performed by the original ticket issuer) and determine if there is a match. If there is a match, the ticket may be validated. If the there is no match, the ticket may be identified as invalid.

If there is a match for the serial number, the app may optionally access ticket details for the event ticket from a ticketing database, including the event, seat(s), event date event time, event venue, face price, etc. Optionally, the ticket details may have been embedded in the serial number or otherwise stored in the physical ticket feature and extracted by the app from the feature. Optionally, in addition to determining whether a ticket is authentic, the app may also determine if the ticket has expired or has already been converted or used and so is no longer valid, by accessing the ticket details and/or a remote database associated with a remote system.

Depending on whether the app determines that the ticket is authentic or is not authentic (or other it has expired, been used up, or already converted), the app provides the user with a corresponding indication. For example, the app may cause the user's device to vibrate, emit a sound or word(s) (e.g., “Ticket valid”, “Ticket successfully authenticated”, “Ticket invalid”, “Ticket failed authentication”, “Ticket expired”, “Ticket already used”, “Ticket already converted”, etc.), or display a message to the user (such as the foregoing messages in text form). If the ticket is authenticated, the system may also transmit the ticket details, or a portion thereof, to the app, which may then be displayed to the user. The user can then verify that the ticket details correspond to the information printed on the ticket. Thus, the foregoing embodiment of the app enables users to verify their own tickets, or those they are interested in purchasing from a third party, quickly and in substantially real time. In the case of a prospective purchase of the scanned ticket, if the ticket fails authentication, the user can decline to purchase the ticket, avoiding disappointment and the loss of the purchase price.

If the ticket is validated, the app may optionally determine whether the ticket is eligible for conversion to an electronic ticket. For example, certain event venues may not be equipped with scanners capable of scanning electronic tickets. In such cases, an indication may be stored in the ticket database indicating that the ticket is not eligible for conversion. Once the ticket has been validated (and optionally, after determining that the ticket is eligible for conversion to an electronic ticket), a convert to eTicket control (or other named control providing the same or similar function, such as an “add to my tickets” control) is displayed and enabled by the app for activation by the user. If the user activates the convert to eTicket control, the app (or a remote system) may generate a new serial number (or use the original serial number), and generate an electronic ticket, which may be stored on the user device and/or the remote system. The remote system may also store the electronic ticket in association with the user's account and user identification information.

The electronic ticket may include a feature, such as a barcode, including the new encrypted serial number, and may optionally include some or all of the ticket details described elsewhere herein. If a new serial number is used, the original serial number may be invalidated by the remote system so that original hard ticket cannot be used and so the hard ticket cannot be used to obtain another electronic ticket. Thus, the barcode (or other feature) of the electronic ticket may be different than that of the physical ticket.

When the user attends the event, the user may access the electronic ticket via the app, which will display the ticket (e.g., a barcode) on the user device. The electronic ticket may then be scanned by a scanner at the event venue for verification by a ticketing system. For example, scanner device may be included in a kiosk, turnstile, handheld device, etc. If the venue system authenticates the ticket and determines that it has not already been “used up”, the user may be granted admission to the venue and event. Optionally, the venue system may generate a physical receipt which may be provided to the user for access to one or more internal or external venue passageways.

While the foregoing description describes an embodiment where certain functions are performed by an app installed on the user device, certain of the foregoing functions may be performed by a remote system.

For example, in another embodiment the live feed or digital photograph of the ticket or feature captured by the user device camera may be transmitted over a network to a remote computer system. The remote system then performs an image analysis and isolates the feature incorporating the encrypted serial number. The remote system extracts and decrypts the serial number (e.g., utilizing the appropriate key). The remote system determines from the serial number whether the ticket is authentic. For example, the remote system may determine whether the serial number is valid by determining whether it is compliance with certain serial number rules, such as whether it contains certain a specified number of characters (e.g., ASCII characters), patterns of characters and/or sequences of characters. By way of further example, in addition or instead the remote system may determine whether the serial number is valid by comparing the serial number to serial numbers in a database of valid, non-expired serial numbers and determine if there is a match. If there is a match, the ticket may be validated. If the there is no match, the ticket may be identified as invalid. If there is a match for the serial number, the system may optionally access ticket details for the event ticket from a ticketing database or stored in the physical ticket feature, including the event, seat(s), event date event time, event venue, etc.

The system may then transmit a ticket valid or ticket invalid message, as appropriate to the app on the user device. In response the app causes a ticket valid or invalid indication to be provided to the user as similarly discussed above. If the ticket is authenticated, the system may also transmit the ticket details, or a portion thereof, to the app, which may then be displayed to the user. The user can then verify that the ticket details correspond to the information printed on the ticket.

In certain embodiments, as similarly discussed above, once the ticket has been validated and a validation message has been transmitted to the user device app, a convert to eTicket control is displayed and enabled by the app for activation by the user. If the user activated or activates the convert to eTicket control, the system may generate a new serial number (or use the original serial number), and generate and transmit an electronic ticket to the user device, which may be stored on the user device, as similarly described above. The electronic ticket may include a feature, such as a barcode, including the new encrypted serial number. When the user attends the event, the user may access the electronic ticket via the app, which will display it on the user device. The electronic ticket may then be scanned by a scanner at the event venue for verification by a ticketing system, and the user may be admitted upon verification.

Certain embodiments may also include a control via which the user can instruct the ticketing system (e.g., that originally issued a user ticket) to transfer the ticket to a designated recipient, or to place a ticket for sale in the secondary market. For example, a user may be able to select an electronic ticket owned by the user from a user interface displaying the user's tickets or a listing thereof, and, via a transfer control, instruct the system to transfer the ticket to a specified individual (e.g., by providing the recipient's name, email address, SMS/MMS address/phone number, account information, etc.). A control may also be provided enabling the user to post a user-selected ticket for resale on a site (e.g., a Website) specified by the user (e.g., by a user menu selection of resale sites) and/or by the system. The system may then post the ticket for sale on the designated site, receive purchase requests from potential ticket buyers, and process the sale of the ticket to the buyer, collect the purchase fee (and other fees) from the buyer, and remit the purchase fee to the user (optionally, minus a service charge). The system may invalidate and/or delete the electronic ticket of the user and issue a new ticket, including a new serial number, to the purchaser.

Optionally, in certain embodiments, the user does not have to log in to a user account in order to use the ticket verification process. Optionally, in certain embodiments, the user needs to log in to a user account in order to use the conversion to eTicket process.

In certain embodiments a physical ticket and/or electronic ticket may be associated with an admission to multiple events (e.g., a season ticket), and/or may entitle the bearer to multiple admissions to a given event (e.g., the ticket may entitle the bearer and a designated number of other people to gain admission to the event).

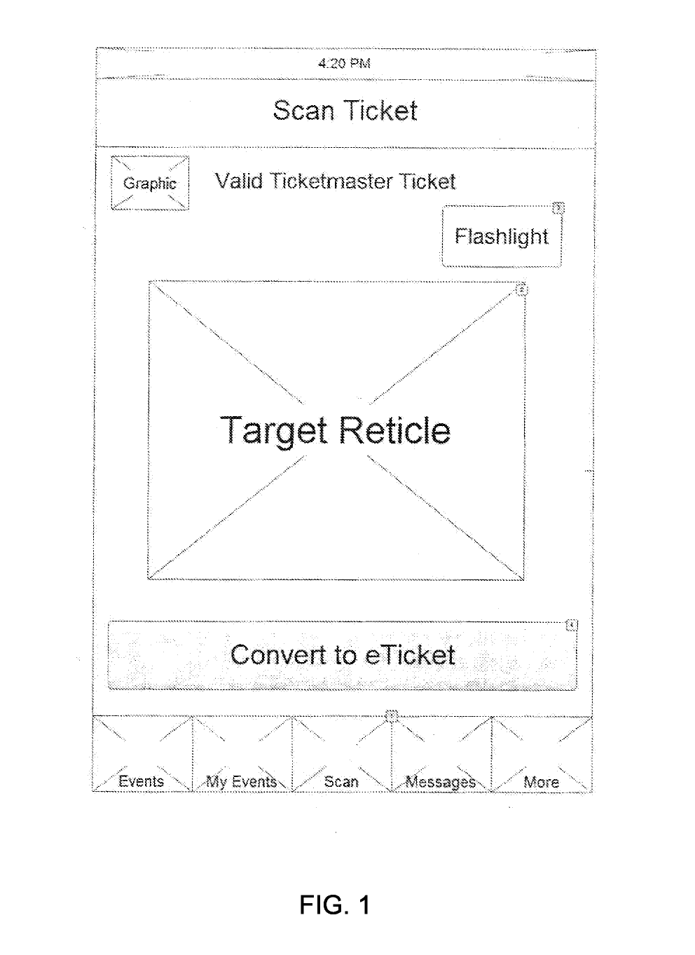

FIG. 1 illustrates an example user interface provided for display on a user device. The user interface includes a scan control, a flashlight control and/or indicator, a target reticle, a convert to eTicket control, an events control, a “my events” control, a scan control, a messages control, and a more menu options control. As similarly described above, the scan control may be utilized to initiate a scan of a ticket or ticket feature. The flashlight control and/or indicator may be used to turn on a flash unit (or other illumination device) of the user device to illuminate the ticket or ticket feature and/or may provide an indication that the flashlight is illuminated. The target reticle may be used as a user aid orienting the ticket or ticket feature with respect to the camera. The convert to eTicket enables the user to provide an instruction that a physical ticket is to be converted to an electronic ticket. The convert to eTicket control is optionally not displayed or is displayed with an inactive indication (e.g., by being grayed out) until a ticket is verified as being authentic.

The events control, when activated by the user, causes information on upcoming local ticketed events to be presented to the user. Activation of the “my events” control causes information on upcoming local ticketed events for performers/teams that the user previously explicitly indicated to be of interest to the user (e.g., by the user activating a control adding the performer/team to a favorites list or by activating a “like” control for the performer/team), or for performers/teams the user has previously purchased tickets for, to be presented to the user. Activation of the messages control may cause messages from a ticket provider, promoter, performer/team, or third parties to be presented to the user (e.g., of upcoming events, ticket onsale times, special offers, etc.). A “my tickets” control may be provided, which when activated will present a list of the user's electronic tickets. The user may tap or otherwise select an electronic ticket from the list, and the electronic ticket (e.g., the ticket barcode or QR code) will then displayed on the user device for scanning. The electronic ticket may be accessed from local device memory or from a database of a remote system. The user may also select a ticket for transfer or sale, as similarly discussed above.

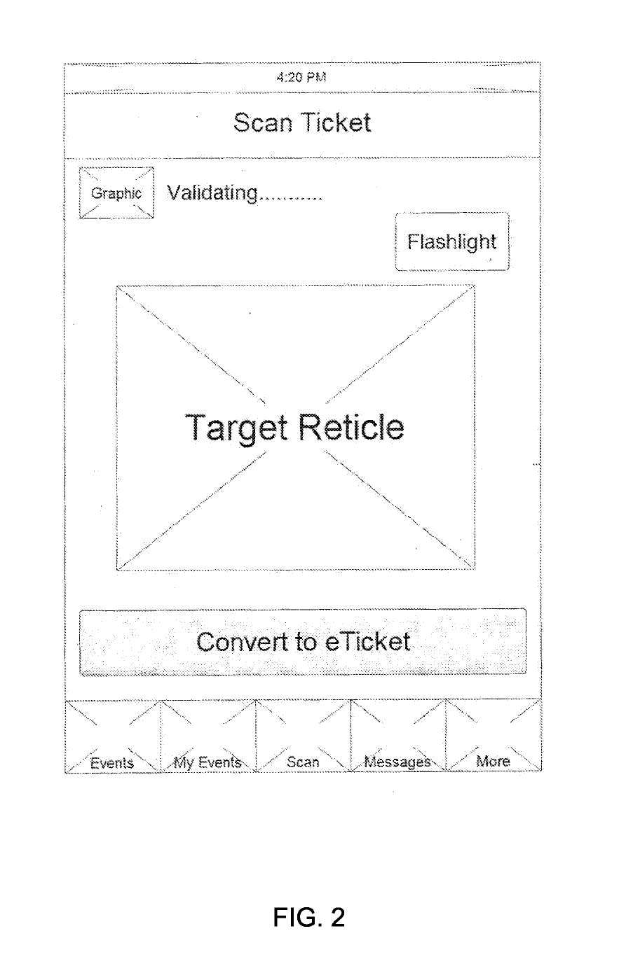

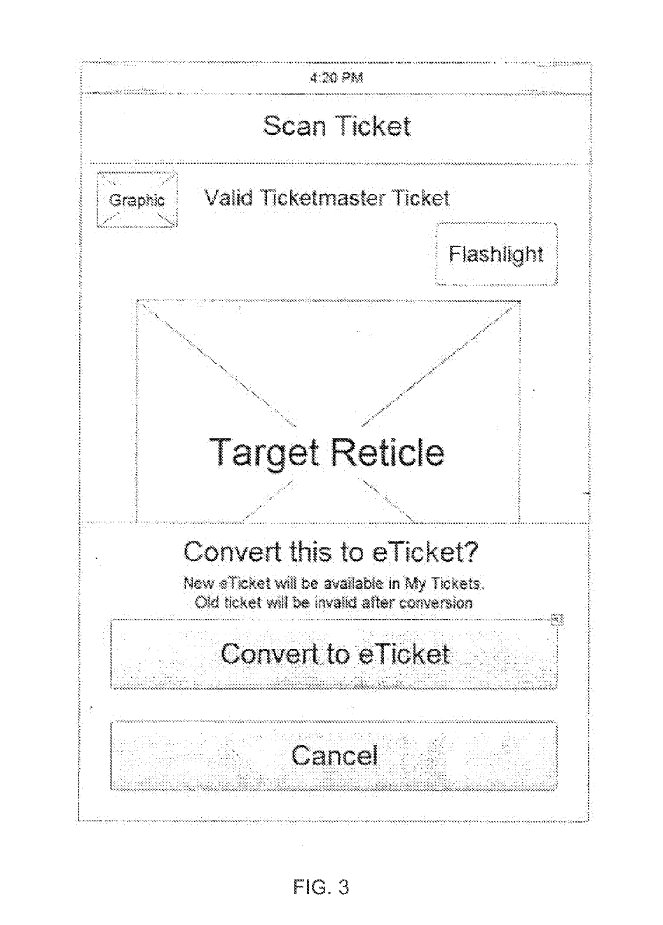

FIG. 2 illustrates the user interface during a validation process. A validation in process message is presented to the user. FIG. 3 illustrates the user interface after a ticket has been authenticated. The convert to eTicket control has been enabled for user activation. A notification is provided to the user that the new electronic ticket will be available in the “my tickets” user interface, and that the old ticket will be invalidated after the conversion. A cancel control is provided via which the user can cause the conversion process to stop. A notification is provided to the user once the conversion is completed. Optionally, in certain embodiments, even if the conversion process is completed, for a specified time thereafter, the user activation of the cancel control will cause the conversion to be undone, where the physical ticket is not cancelled, and the electronic ticket is cancelled.

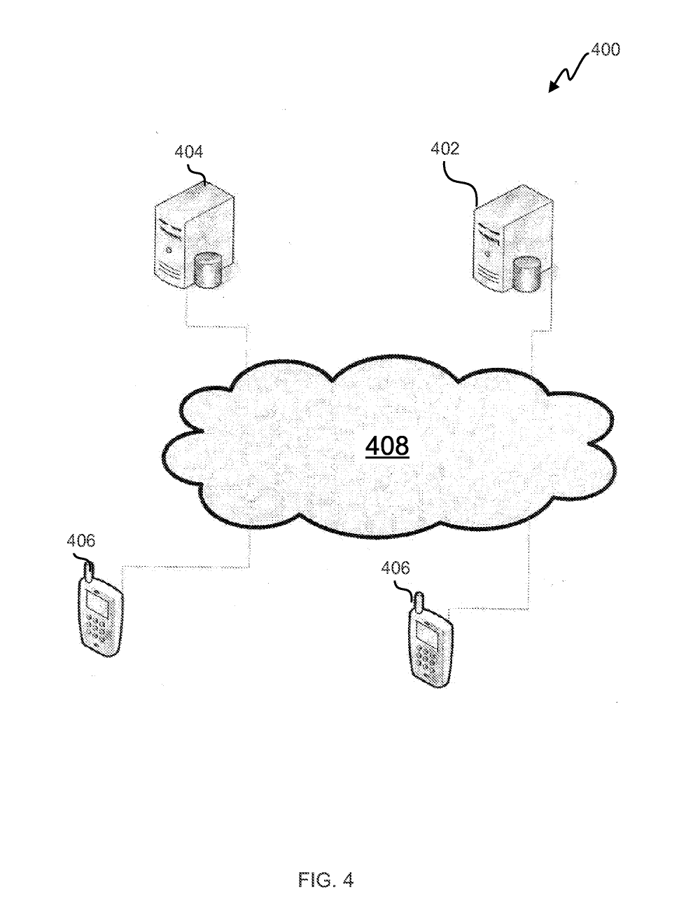

FIG. 4 illustrates an example architecture that can be utilized with certain embodiments. A ticket system may include one or more ticket verification servers 402 storing ticket data, such as ticket serial numbers, seat identifiers corresponding to the tickets, event data (e.g., event/performer/team name, data, time, venue) corresponding to the tickets, an indication as to whether a physical ticket is eligible for conversion to an electronic ticket, identifiers of ticket holders, ticket holder account information, etc.

The ticket system optionally includes account manager servers, a credit card authorization system, an internal network, request routers, data and status queues, and interfaces to one or more networks, optionally including the cellular networks, telephony networks, the Internet, etc. The ticket system optionally hosts a Website accessible by users for searching for, purchasing, transferring, and selling tickets. The ticket system may include one or more databases whose data can be accessed as needed. For example, the databases can include a user account database that stores user contact information, billing information, preferences, account status, ticket inventory currently held and historically held by the user (and the associated ticket statuses), settlement information, and the like. The ticket system stores rules indicating which tickets may be posted for resale, barcode/serial number data for event tickets, event data (e.g., event identifier, performer/sports team name, event venue, event date, event time, whether the event has been cancelled, whether the event has been rescheduled, etc.), venue data (e.g., seating charts and information, such as section/row/seat number data), and so on.

The ticket system may also track how many tickets, and for which events, have successfully been verified and how many have failed to successfully verify over a given period of time. The ticket system may be programmed to spot trends in terms of how many tickets for which events have failed verification for a given period of time, and generate an alert (e.g., in the form of an email, SMS message, MMS message, webpage, on screen notification, or otherwise) to specified entities/users based on one or more rules. For example, a rule may specify that if more than a certain number of tickets for a given event have failed authentication over a specified period of time (50 tickets for a given event over 48 hours having failed authentication), an alert is to be generated.

Reports may also be generated, printed and/or displayed, optionally in substantially real time, providing other transaction data monitored and/or stored by the system. For example, the system may generate reports indicating how many tickets have been authenticated or undergone attempted authentication, for which events, in which localities, in what time period, etc. Further, the system may generate reports indicating how many tickets have been converted for which events, in which localities, in what time period, etc. Additionally, the system may generate reports indicating how many tickets have been transferred for which events, in which localities, in what time period, etc. The reports may also include demographic information, identification information, and/or other information about each of the parties participating in the foregoing activities.

An application download system server 404 stores the ticketing app which may be downloaded to user devices. User devices 406 are coupled to the ticket verification server 402 and the application download server 404 via one or more networks 408.

Buyers and sellers may access the ticket system via user terminals so as to purchase tickets, sell tickets, transfer tickets, manage their accounts, via their tickets for upcoming events, view their tickets for past events, etc. Thus, the ticket system may display to the user the user's account information, including tickets that the user has and has not converted into electronic tickets.

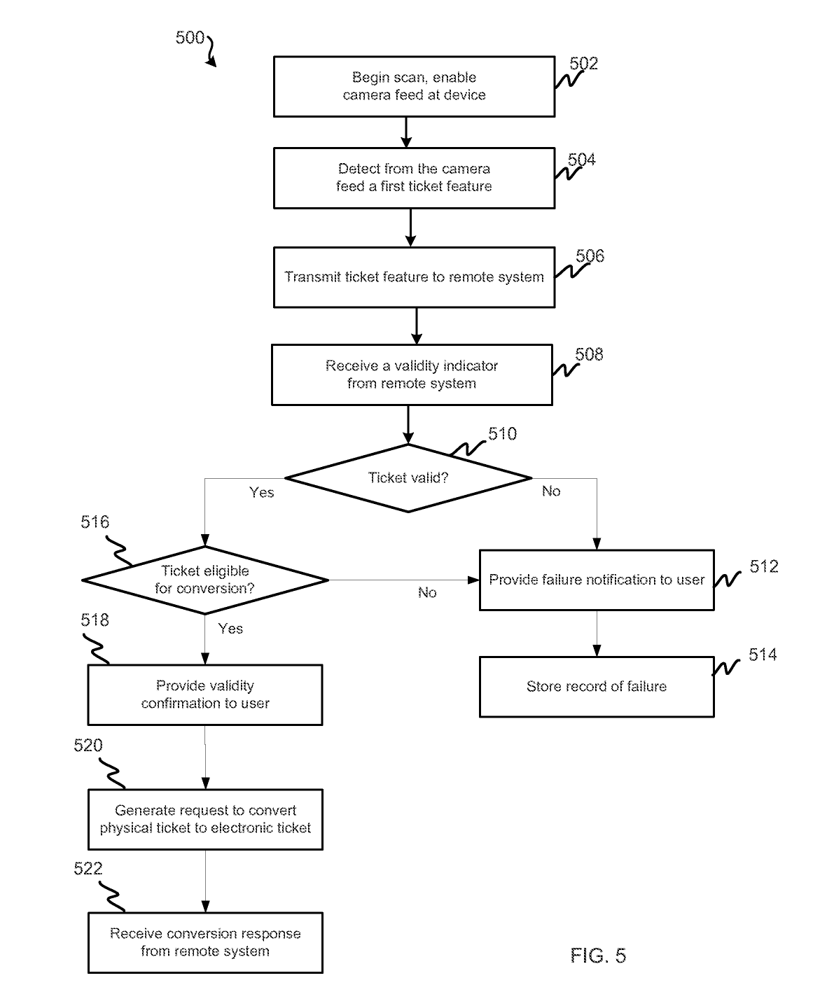

FIG. 5 illustrates an example validation and conversion process. Various actions may be performed by an application on a user device. At block 502, a user scan instruction is received via a user device, and the user device begins capturing still or motion images of a ticket or ticket feature using a device camera of a mobile device, such as a cellular phone, smart phone, tablet, or the like. The camera of the mobile device may be activated to start capturing video and/or still images of the physical ticket. For example, a user can start an app or press an icon so as to indicate that the user is requesting that the camera be activated to scan a ticket feature.

At block 504, a determination is made (e.g., by an application) as to whether a desired ticket feature has been successfully imaged. If not, the process may proceed to repeat the scan and/or continuously monitor the feed from the camera. Optionally, if the feature is not successfully imaged after a specified period of time, the scan will halt and an error indication is provided by the user (e.g., via sound, text, color, graphic, vibration, or otherwise).

As one example, in order to determine whether the ticket feature has been successfully imaged, the mobile device may be configured to detect (e.g., via an application) a specific feature on the ticket. The feature may be, for example, a specific pattern or one or more colors. The patterns and or colors may be detected and used to locate or image a first ticket feature that may include a machine readable code or feature such as bar code or alphanumeric sequence, for example. If the ticket feature is not successfully imaged, the process may attempt to change camera configuration such as turning on or off the light of flash of the camera or providing instructions and/or indications to the user to adjust lighting or position the ticket. In some embodiments, the application may provide positive feedback (e.g., via sound, text, color, graphic, vibration, or otherwise) to the user via the mobile user device indicating the scan has been successfully completed.

At block 506, the first ticket feature (e.g., an image, video feed, machine readable code, and/or code) may be transferred (e.g., over a network, such as a wireless network) to a remote system for validation and/or authentication. At block 508, a validity indicator may be received from the remote system. The validity indicator can indicate whether the ticket feature corresponds to a valid ticket. The indicator may be accompanied by other information, such a reason for invalidity; a venue, event or date associated with the ticket; and/or a seat identifier associated with the ticket. At block 510, the mobile device may determine whether the validity indicator is indicates that a ticket associated with the ticket feature is valid.

If the received indication of validity is negative, at block 512, the mobile device may provide a validity failure notification to the user. The failure indication may include possible reasons for the failure. For example, an indication may be provided that the ticket has already been used or converted, that the ticket has expired, that a quota in the ticket has been reached that an event associated with the ticket has already occurred, or that a condition associated with the ticket has not been met. In some cases, the mobile device may store details of each validity failure. An application on the mobile device may track how many invalid tickets the mobile device has been used to scan or check. The mobile device or the application on the mobile device may be configured to disable further scanning and/or conversion of tickets after a threshold of scans of invalid tickets. A record of consecutive scans of invalid tickets may indicate fraudulent activity for example.

If the ticket is authenticated and/or validated by the remote system, then a corresponding notification may be provided to the user via the user device in block 516. If, In some instances, no explicit indication is provided, though such indication is implicit in allowing the process to progress to a conversion of the ticket. [0054] At block 514, a record of the validity failure can be stored. The record can include, e.g., an identifier of the user, of an event associated with ticket feature, the ticket feature, an identifier of any user that previously used the ticket and/or a date of the receipt of the validity indicator. Such details may, for example, be used to later prevent a given user from requesting electronic ticket conversion (e.g., responsive to an above-threshold number of validity-failure indicators).

At block 516, a determination is made as to whether the successfully validated ticket is eligible for conversion. This determination can be made locally and/or by analyzing a response from a remote system. This determination can be made using the ticket feature or made using another ticket feature (e.g., image, bar code, and/or alphanumeric code). In the latter case, the determination may include analyzing a previously imaged portion of a ticket, collecting and/or analyzing a new portion of a ticket and/or transmitting a same or different ticket feature to the remote system.

In some instances, the determination depends on information pertaining to a user or mobile device requesting the conversion. For example, a conversion may require that a requesting device be associated with a holder of the ticket (e.g., identified based on stored information). As another example, a conversion may require that a user be logged into an account (e.g., any account, an account associated with the ticket holder or an account otherwise associated with the ticket).

In some instances, conversion eligibility also depends on one or more of a time before an event (e.g., only allowing conversions 24 hours before the event), a type of event, a performer of the event, a type of ticket (e.g., such that conversions are only allowed for prime or convertible tickets), and/or a fee status (e.g., requiring that a conversion fee have been paid during purchase of the ticket or conversion request or requiring that a user agree to pay such a fee).

The determination can be made based on a query (e.g., from a mobile device or remote system) to a data store or information service to determine if the ticket is eligible for conversion. Some venues, for example, may not have a capability to accept electronic tickets for entry and therefore a conversion request from the remote system should not be made. The mobile device may receive data from the ticket provider and determine the conversion restrictions for the ticket and/or venue.

In one instance, a communication received from the remote system that included the validity indicator can further indicate whether the ticket is eligible for conversion.

When it is determined that the ticket is not eligible for conversion, process 500 can continue to block 512, where a failure notification can be provided to the user. This failure notification may, or may not, differ from one provided responsive to a ticket invalidity determination. For example, the notification may include a reason why the ticket is not eligible for conversion. In some instances, the notification provides an opportunity to remedy an identified problem (e.g., by allowing a user to thereafter submit a conversion fee or log into an account). A record of the failure can be stored at block 514.

Meanwhile, when it determined that the ticket is eligible for conversion, process 500 can continue to block 518 where a validity confirmation can be provided to a user. The validity confirmation can include an explicit or implicit validity indication. In some instances, an option to proceed with a conversion (e.g., a display of a conversion control) is itself an indication that a ticket is eligible for conversion. Optionally, a cancel control may be provided for display on the user device as well.

Process 500 can conditionally (e.g., conditioned upon receiving an explicit conversion request subsequent to a ticket validity or conversion-eligibility analysis) or unconditionally proceed to block 520 where a conversion request may be generated and transmitted from the mobile device to the remote system. The request can be indicative of a request to convert a physical ticket (e.g., corresponding to a ticket imaged at block 502) to an electronic ticket

At block 522, a conversion response from the remote system may be received by the mobile device. The conversion response may include an indication that the conversion has been performed. In some instances, the response can include an electronic ticket feature corresponding to the physical ticket. The electronic ticket feature may include a barcode, alphanumeric code or other authentication information, and optionally includes ticket details in machine and/or human readable form (e.g., an event identifier, venue, date, time, seat number, etc.). An electronic ticket can itself be generated at the mobile device (e.g., to include a received electronic ticket feature) or at the remote system. The electronic ticket may be stored on the user device and/or on the remote system. The electronic ticket can thereafter be displayed on the mobile device (e.g., as an indication that the conversion has occurred or responsive to a subsequent user input that may be received, for example, during a redemption attempt). The physical ticket may be invalidated (e.g., by storing an invalid indicator in association with the ticket serial number of other identifier in a ticket database), to prevent the physical ticket from being used to gain access to the event.

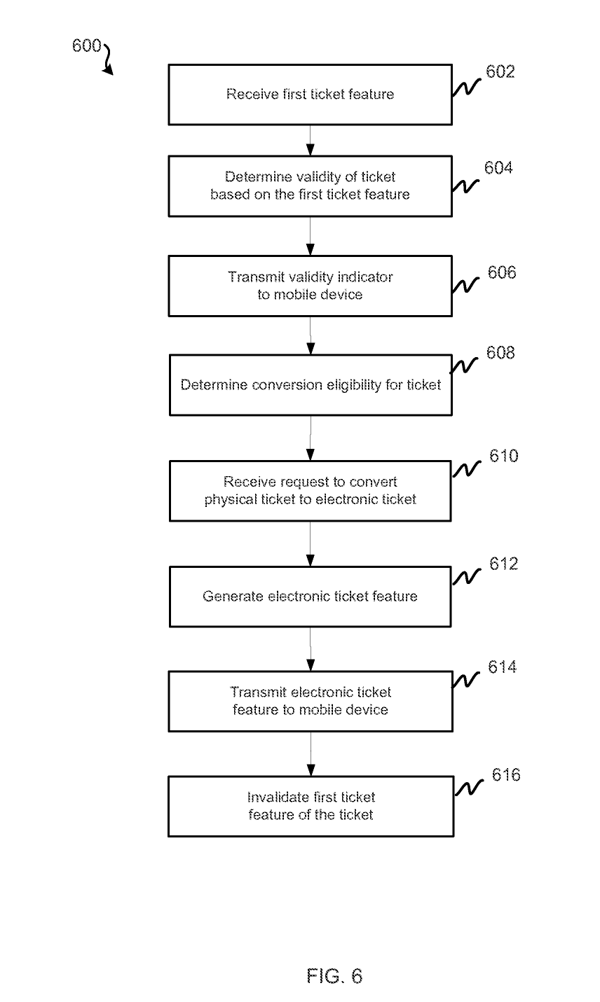

FIG. 6 illustrates an example validation and conversion process that may be performed by a remote system such as a remote validation system. It will be appreciated that select blocks of process 600 may be complementary to corresponding blocks in process 500.

In block 602, the remote system may receive a ticket from a mobile user device. In some embodiments the remote system may receive a raw image with a machine readable feature that may be deciphered or detected by the remote system. In other embodiments, such feature-extraction may be performed at the mobile device, such that only a portion of an image and/or a processed version thereof (e.g., an alphanumeric sequence) is received.

In block 604, the remote system may determine the validity of the received ticket features. This determination may be performed by, for example, using a look-up operation (e.g., to determine if the feature is included in a valid-ticket-feature data store or to determine whether a redemption has been associated with the feature) or to determine whether a pattern in the feature corresponds to a stored valid pattern. The determination can further include detecting and/or analyzing the feature to determine whether the ticket has expired. In some embodiments the determination may include performing computations, decryption, or other operations on the image or codes related to the received ticket feature.

At block 606, a validity indicator can be transmitted to a mobile device from which the first ticket feature was received. Process 600 can conditionally (e.g., conditioned on receipt of a communication being received from the mobile device subsequent to the validity determination and/or conditioned on a valid ticket determination) or unconditionally proceed to block 608 where it can be determined whether the ticket is eligible for conversion. This determination can be based on an analysis of the first ticket feature or a second ticket feature (e.g., received from the mobile device and/or extracted at the remote system from an image). Conversion eligibility can depend on whether a conversion has already occurred for the ticket, a type of the ticket, whether a user purchased a convertible ticket, whether a conversion fee was paid (e.g., at ticket-purchase or a time of a conversion request), and/or whether a user or mobile device associated with a conversion request (e.g., as indicated in a communication including the first ticket feature) is authorized to convert the ticket. In some instances, a conversion-eligibility indicative of the determination can be sent to the mobile device. In some instances, a single indicator (e.g., indicating whether a ticket feature is both valid and conversion eligible or whether it does not satisfy both criteria) is transmitted.

One or both of the validity and/or conversion-eligibility determinations can be stored. Further, details pertaining to a validity-assessment and/or conversion request can also be stored. For example, a log entry can indicate that a particular mobile device requested conversion of a ticket with a particular ticket feature on a particular date and that the ticket associated with the ticket feature was not eligible for conversion. Such information may be used to determine trends or patterns in identified invalid or conversion-ineligible tickets.

In block 610, the remote system may receive a conversion request indicating that a user is requesting that a physical ticket associated with the first ticket feature be converted into an electronic ticket. In some instances, this request is explicit or implicit in a communication received at block 602 that included the first ticket feature. An electronic ticket can allow a user to access and/or redeem the ticket using an electronic device. Thus, rather than having a single physical instance of a ticket, which may have a risk of being damaged, lost or destroyed, an electronic ticket can be electronically viewed, downloaded or otherwise retrieved. An electronic ticket may further provide a user with an opportunity to electronically transfer the ticket to another person without needing to physically meeting with the other person. In some instances, the request can identify a ticket holder, which may be a current ticket holder or which may be someone to whom the ticket holder is transferring the ticket to.

In block 612, the validation system may generate an electronic ticket feature (e.g., machine-readable code, barcode, alphanumeric sequence or image) corresponding to the first ticket feature. In some instances, the electronic ticket feature is the same as the first ticket feature, and (for example) a ticket-type indicator associated with the feature can be changed to reflect that the feature is for an electronic ticket. In some instances, at least part of the electronic ticket feature is the same as at least part of the first ticket feature. In some instances, the electronic and physical ticket features are different. Each of the first ticket feature and the electronic ticket may correspond to a same event, venue, date and/or seat. The electronic ticket feature may be computed or determined based on a feature and/or code associated with the physical ticket.

In some instances, an electronic ticket is generated. Electronic ticket generation can include generation of the electronic ticket feature or can be subsequently performed. The electronic ticket can include the electronic ticket feature. For example, an electronic ticket can include an image with a machine-readable code. The electronic ticket may include data or features that may be displayed on the mobile device allowing a venue scanner or ticket agent to read or electronically read the electronic ticket from the mobile user device.

In block 614, the electronic ticket feature may be transmitted to the mobile device. The electronic ticket feature can also be stored in a data store. The electronic ticket feature can be stored in association with, e.g., a mobile device identifier, user identifier, and/or indication that it is a feature for an electronic (versus physical) ticket.

In block 620, the physical ticket can be invalidated. This invalidation can be accomplished by, e.g., invalidating the first ticket feature, such as deleting it from a valid data store or associating an invalidity indication with the first ticket feature. The invalidation can serve to prevent redemption of the physical ticket or another conversion of the physical ticket.

While processes 500 and 600 illustrate one example of how a mobile device and remote system can interact to convert a ticket, it will be appreciated that the processes may be modified such that one or more blocks shown to be performed by the mobile device are instead performed by the remote system and/or such that one or more blocks shown to be performed by the remote system are instead performed by the mobile device.

Certain embodiments enable a user to scan indicia on a ticket, such as a barcode, marker, dot, graphic, or picture, for ticketing or non-ticketing purposes (e.g., where the user scans the indicia using a user device such as a wireless phone, optionally with the app discussed above installed). The indicia may include a link to data (e.g., in the form of a coded URL), may include a code (e.g., a key) needed to identify and unlock data (stored locally on the user device or on a remote system), and/or may have coded data embedded therein which may be decoded and displayed to the user by the user device (e.g., using the app).

For example, a user may scan ticket indicia which may include embedded data and/or may be associated with a link to data. Optionally, the indicia may include or provide access to (e.g., via a link or code) content such as event details (e.g., the date, time, venue, performer name(s), set list, etc.), the face value ticket price of the ticket being scanned, the current estimated resale value (e.g., based on an statistical analysis (e.g., an average or median) of current resale offers for similar tickets for the event and/or sale prices for completed resales obtained from one or more resale sites), seating charts, seating charts indicating where the user's friends are sitting in the event venue, an augmented Reality (AR) stadium view (e.g., in visual 3D), a video clip (e.g., of the performer in 2D or 3D), a list of the user's friends who are going, music, etc.

The foregoing information may be obtained as follows. The app may transmit data corresponding to the scanned indicia to a remote system. The remote system utilizes the data to identify and access the corresponding data from its database (or a third party database), and transmits the corresponding information to the user device for display to the user or for use by the app.

Thus, certain embodiments enable a user to validate a physical, printed ticket using a camera built into a user device. Certain embodiments enable ticket holders to convert their inconvenient physical, hard ticket to a digital electronic, ticket. Further, certain embodiments facilitate the transfer and sale of tickets.

Unless otherwise indicated, the functions described herein may be performed by software (e.g., including modules) including executable code and instructions running on one or more systems including one or more computers, such as barcode and/or other authentication computer systems. The software may be stored in computer readable media (e.g., some or all of the following: optical media (e.g., CD-ROM, DVD, Blu-ray, etc.), magnetic media (e.g., fixed or removable magnetic media), semiconductor memory (e.g., RAM, ROM, Flash memory, EPROM, etc.), and/or other types of computer readable media.

The one or more computers can include one or more central processing units (CPUs) that execute program code and process data, non-transitory, tangible memory, including. for example, one or more of volatile memory, such as random access memory (RAM) for temporarily storing data and data structures during program execution, non-volatile memory, such as a hard disc drive, optical drive, or FLASH drive, for storing programs and data, including databases,” a wired and/or wireless network interface for accessing an intranet and/or Internet, and/or other interfaces.

In addition, the computers can include a display for displaying user interfaces, data, and the like, and one or more user input devices, such as a keyboard, mouse, pointing device, touch screen, microphone and/or the like, used to navigate, provide commands, enter information, provide search queries, and/or the like. The systems described herein can also be implemented using general-purpose computers, special purpose computers, terminals, state machines, and/or hardwired electronic circuits.

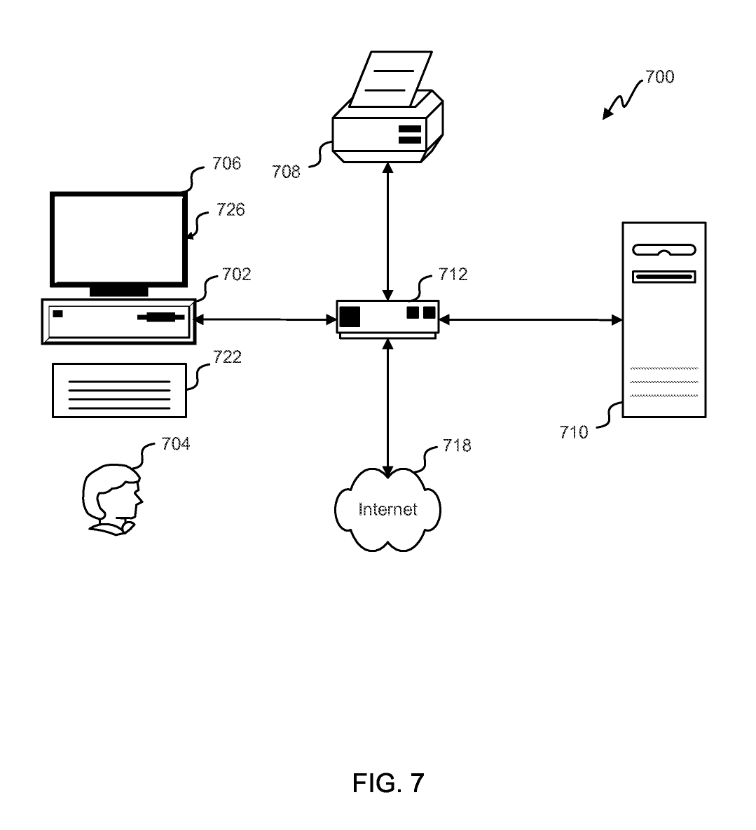

Referring next to FIG. 7, an exemplary environment with which embodiments can be implemented is shown with a computer system 700 that can be used, e.g., by a mobile device and/or remote system to convert a physical ticket to an electronic ticket. The computer system 700 can include a computer 702, keyboard 722, a network router 712, a printer 708, and a monitor 706. The monitor 706, processor 702 and keyboard 722 are part of a computer system 726, which can be a laptop computer, desktop computer, handheld computer, mainframe computer, etc. Monitor 706 can be a CRT, flat screen, etc.

A user can input commands into computer 702 using various input devices, such as a mouse, keyboard 722, track ball, touch screen, etc. If the computer system 700 comprises a mainframe, a user can access computer 702 using, for example, a mobile device. Additionally, computer system 726 can be connected to a printer 708 and a server 710 using a network router 712, which can connect to the Internet 718 or a WAN.

Server 710 can, for example, be used to store additional software programs and data. In one embodiment, software implementing the systems and methods described herein can be stored on a storage medium in server 710. Thus, the software can be run from the storage medium in server 710. In another embodiment, software implementing the systems and methods described herein can be stored on a storage medium in computer 702. Thus, the software can be run from the storage medium in computer system 726. Therefore, in this embodiment, the software can be used whether or not computer 702 is connected to network router 712. Printer 708 can be connected directly to computer 702, in which case, computer system 726 can print whether or not it is connected to network router 712.

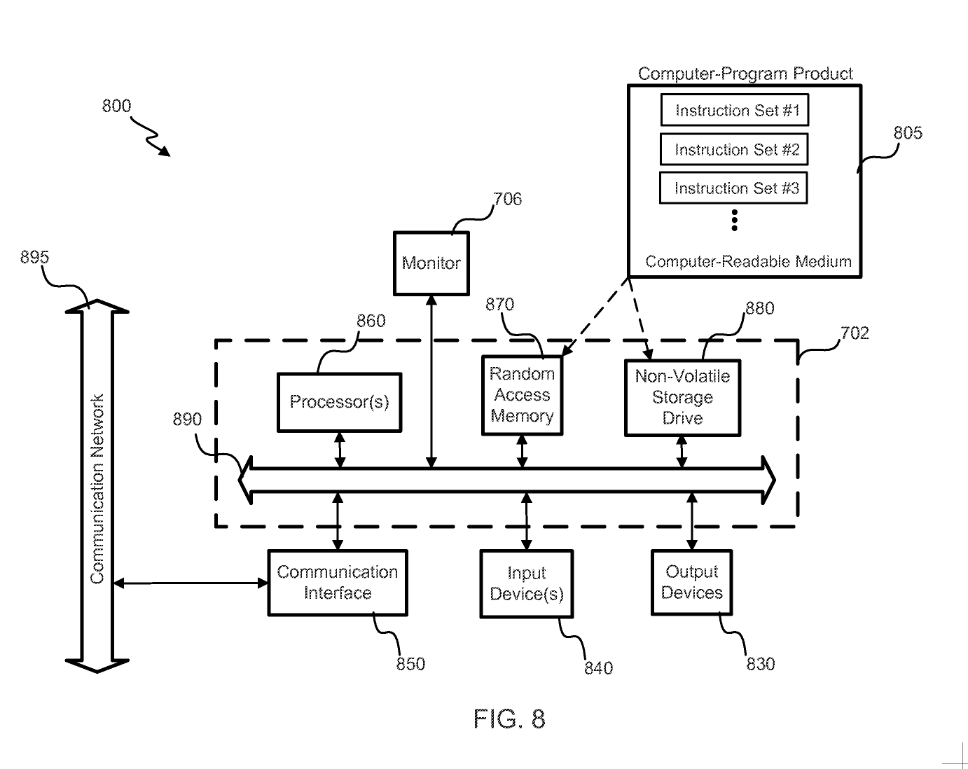

With reference to FIG. 8, an embodiment of a special-purpose computer system 800 is shown. One or more special-purpose computer systems 800 can be used to validate and/or convert a ticket. The above methods can be implemented by computer-program products that direct a computer system to perform the actions of the above-described methods and components. Each such computer-program product can comprise sets of instructions (codes) embodied on a computer-readable medium that directs the processor of a computer system to perform corresponding actions. The instructions can be configured to run in sequential order, or in parallel (such as under different processing threads), or in a combination thereof. After loading the computer-program products on a general purpose computer system 726, it is transformed into the special-purpose computer system 800.

Special-purpose computer system 800 comprises a computer 702, a monitor 706 coupled to computer 702, one or more additional user output devices 830 (optional) coupled to computer 702, one or more user input devices 840 (e.g., keyboard, mouse, track ball, touch screen) coupled to computer 702, an optional communications interface 850 coupled to computer 702, a computer-program product 805 stored in a tangible computer-readable memory in computer 702. Computer-program product 805 directs system 800 to perform the above-described methods. Computer 702 can include one or more processors 860 that communicate with a number of peripheral devices via a bus subsystem 890. These peripheral devices can include user output device(s) 830, user input device(s) 840, communications interface 850, and a storage subsystem, such as random access memory (RAM) 870 and non-volatile storage drive 880 (e.g., disk drive, optical drive, solid state drive), which are forms of tangible computer-readable memory.

Computer-program product 805 can be stored in non-volatile storage drive 890 or another computer-readable medium accessible to computer 702 and loaded into memory 870. Each processor 860 can comprise a microprocessor, such as a microprocessor from Intel® or Advanced Micro Devices, Inc®, or the like. To support computer-program product 805, the computer 702 runs an operating system that handles the communications of product 805 with the above-noted components, as well as the communications between the above-noted components in support of the computer-program product 805. Exemplary operating systems include Windows® or the like from Microsoft Corporation, Solaris® from Sun Microsystems, LINUX, UNIX, and the like.

User input devices 840 include all possible types of devices and mechanisms to input information to computer system 702. These can include a keyboard, a keypad, a mouse, a scanner, a digital drawing pad, a touch screen incorporated into the display, audio input devices such as voice recognition systems, microphones, and other types of input devices. In various embodiments, user input devices 840 are typically embodied as a computer mouse, a trackball, a track pad, a joystick, wireless remote, a drawing tablet, a voice command system. User input devices 840 typically allow a user to select objects, icons, text and the like that appear on the monitor 706 via a command such as a click of a button or the like. User output devices 830 include all possible types of devices and mechanisms to output information from computer 702. These can include a display (e.g., monitor 706), printers, non-visual displays such as audio output devices, etc.

Communications interface 850 provides an interface to other communication networks and devices and can serve as an interface to receive data from and transmit data to other systems, WANs and/or the Internet 718. Embodiments of communications interface 850 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 850 can be coupled to a computer network, to a FireWire® bus, or the like. In other embodiments, communications interface 850 can be physically integrated on the motherboard of computer 702, and/or can be a software program, or the like.

RAM 870 and non-volatile storage drive 880 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 870 and nonvolatile storage drive 880 can be configured to store the basic programming and data constructs that provide the functionality of various embodiments of the present invention, as described above.

Software instruction sets that provide the functionality of the present invention can be stored in RAM 870 and non-volatile storage drive 880. These instruction sets or code can be executed by processor(s) 860. RAM 870 and non-volatile storage drive 880 can also provide a repository to store data and data structures used in accordance with the present invention. RAM 870 and non-volatile storage drive 880 can include a number of memories including a main random access memory (RAM) to store of instructions and data during program execution and a read-only memory (ROM) in which fixed instructions are stored. RAM 870 and non-volatile storage drive 880 can include a file storage subsystem providing persistent (non-volatile) storage of program and/or data files. RAM 870 and nonvolatile storage drive 880 can also include removable storage systems, such as removable flash memory.

Bus subsystem 890 provides a mechanism to allow the various components and subsystems of computer 702 communicate with each other as intended. Although bus subsystem 890 is shown schematically as a single bus, alternative embodiments of the bus subsystem can utilize multiple busses or communication paths within computer 702.

Specific details are given in the above description to provide a thorough understanding of the embodiments. However, it is understood that the embodiments can be practiced without these specific details. For example, circuits can be shown in block diagrams in order not to obscure the embodiments in unnecessary detail. In other instances, well-known circuits, processes, algorithms, structures, and techniques can be shown without unnecessary detail in order to avoid obscuring the embodiments.

Implementation of the techniques, blocks, steps and means described above can be done in various ways. For example, these techniques, blocks, steps and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in the figure. A process can correspond to a method, a function, a procedure, a subroutine, a subprogram, etc. When a process corresponds to a function, its termination corresponds to a return of the function to the calling function or the main function.

Furthermore, embodiments can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware and/or software implementation, the methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

While various systems are described herein (e.g., a posting system, a verification system, a ticket system, etc.), optionally some are or all of the various systems can be included a single system operated by a single operator (e.g., a system operated by an initial issuer of tickets).

While the foregoing examples include reference to barcodes, other types of codes, including other types of unique codes assigned to event tickets, may be similarly verified and used to access data stored in memory, such as in databases. For example, other types of alphanumeric and/or machine readable codes may be used. While certain types of notifications may be referred to, other notifications may be used as well. For example, a notification may be in the form of sound, text, color, graphic, vibration, and/or other form. While certain user interfaces may be described, other user interfaces may be used.

The example processes described herein do not necessarily have to be performed in the described sequence, and not all states have to be reached or performed.

Unless the context otherwise indicates, the term “field” with respect to a user interface or form is intended to refer to a user entry mechanism via which the user can input data or commands, such as a text field or a menu via which the user can make a selection, etc.

Various embodiments provide for communications between one or more systems (e.g., an authentication system, a ticket system, etc.) and one or more users (e.g., a ticket holder, a ticket purchaser and/or a ticket seller). These user communications may be provided to a user terminal (e.g., an Interactive television, a phone, a video game system, a laptop/desktop computer, a device providing Internet access, or other networked device). For example, communications may be provided via Webpages, downloaded documents, email, SMS (short messaging service) message, MMS (multimedia messaging service) message, terminal vibrations, other forms of electronic communication text-to-speech message, otherwise. Commands and data received by the ticket and authentication systems may be stored in memory and processed and transformed as discussed herein.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

What is claimed is:

1. A method of validating a physical ticket for an event using a mobile device, the method comprising:
enabling monitoring of a camera feed from the mobile device;
detecting from the camera feed, a first ticket feature of the physical ticket, the first ticket feature including a first machine-readable code;
transmitting the first ticket feature to a remote system;
receiving a validity indication from the remote system for the first machine readable code;
generating a request to convert the physical ticket into an electronic ticket, the request including the first ticket feature; and
receiving a response to the request indicating that the conversion has occurred such that the first machine readable code has been invalidated.

2. The method of claim 1, further comprising providing a corresponding validity indication to a user via the mobile device.

3. The method of claim 1, wherein the response further indicates that a second ticket feature has been generated, the second ticket feature including a second machine-readable code.

4. The method of claim 3, wherein the second ticket feature is generated at a remote system.

5. The method of claim 1, further comprising receiving the electronic ticket.

6. The method of claim 1, wherein the request includes the first ticket feature, and wherein the response includes the validity indication.

7. The method of claim 1 further comprising
decrypting the first machine readable code using a key to produce a decrypted code; and
transmitting the decrypted code to the remote system.

8. The method of claim 1 further comprising transmitting a notification to one or more systems remote from the mobile device indicating that the physical ticket has been invalidated.

9. A system for validating a physical ticket for an event using a mobile device, the system comprising:
one or more processors; and
one or more memories coupled with the one or more processors, wherein the one or more processors and one or more memories are configured to:
enable monitoring of a camera feed from the mobile device;
detect from the camera feed, a first ticket feature of the physical ticket, the first ticket feature including a first machine-readable code;
transmit the first ticket feature to a remote system;
receive a validity indication from the remote system for the first machine readable code;
generate a request to convert the physical ticket into an electronic ticket, the request including the first ticket feature; and
receive a response to the request indicating that the conversion has occurred such that the first machine readable code has been invalidated.

10. The system of claim 9, wherein the one or more processors and one or more memories are further configured to provide a corresponding validity indication to a user via the mobile device.

11. The system of claim 9, wherein the response further indicates that a second ticket feature has been generated, the second ticket feature including a second machine-readable code.

12. The system of claim 9, wherein the one or more processors and one or more memories are further configured to receive the electronic ticket.

13. The system of claim 9, wherein the request includes the first ticket feature, and wherein the response includes the validity indication.

14. The system of claim 9, wherein the second ticket feature is generated at a remote system.

15. The system of claim 9, wherein the one or more processors and one or more memories are further configured to:
decrypt the first machine readable code using a key to produce a decrypted code; and
transmit the decrypted code to the remote system.

16. The system of claim 9, wherein the one or more processors and one or more memories are further configured to transmit a notification to one or more systems remote from the mobile device indicating that the physical ticket has been invalidated.

17. A method of validating a physical ticket for an event, the method comprising:
receiving, from a mobile device, an image of a first ticket feature of a physical ticket, the first ticket feature including a first machine-readable code;
determining the validity of the physical ticket based on the first machine-readable code of the first ticket feature;
transmitting a validity indication to the mobile device for the first machine readable code;
receiving, from the mobile device, a request to convert the physical ticket into an electronic ticket, the request including the first ticket feature;
generating the electronic ticket based on the first ticket feature;
storing the electronic ticket; and
transmitting a response to the request indicating that the conversion has occurred.

18. The method of claim 17, wherein the response further indicates that a second ticket feature has been generated, the second ticket feature including a second machine-readable code.

19. The method of claim 17 further comprising:
decrypting the first machine readable code using a key to produce a decrypted code; and
comparing the decrypted code to a set of valid codes.

20. The method of claim 17 further comprising transmitting a notification to the mobile device indicating that the physical ticket has been invalidated.
